(19) United States
(12) Patent Application Publication
(10) Pub. No.: US 2009/0087130 A1
(43) Pub. Date: Apr. 2, 2009

(54) RUNNER PLATE WITH INTEGRATED ROLLING BODY RACEWAY

(75) Inventors: Rainer Schenk, Furth (DE); Michael Bogner, Eckental (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/161,608

(22) PCT Filed: Dec. 19, 2006
(86) PCT No.: PCT/EP06/69884

§ 371 Date: Jul. 21, 2008

(30) Foreign Application Priority Data
Jan. 21, 2006 (DE) 10 2006 002 966.6

(51) Int. Cl. F16C 13/00

(52) U.S. Cl. 384/418

(57) ABSTRACT

The invention relates to a rolling-bearing-mounted runner plate, which is configured as a single piece produced by means of a non-cutting process, for a traction mechanism drive. The runner plate, which has a C-shaped cross-sectional profile, forms a hub in which a raceway is formed for the guidance of rolling bodies of a rolling bearing.

### FIELD OF THE INVENTION

The invention relates to a runner plate for a traction drive with a cross-sectional profile of C-shaped configuration. The runner plate, produced in one piece and designed as a non-cutting-machined part, is connected, in the installation state, to a traction means via a surface area. The hub of the runner plate is connected indirectly or directly to a rolling bearing.

### BACKGROUND OF THE INVENTION

Known runner plates are mounted rotatably by means of conventional rolling mountings, for example an outer ring being pressed by means of a press fit into the hub of the deep-drawn runner plate. This type of construction requires high production costs and complicated assembly and involves the disadvantage of a large component range, along with a relatively high weight. In addition, the press fit between the rolling bearing and the runner plate hub has an adverse influence on the radial play of the pressed-in rolling bearing. Furthermore, there is the risk that, if manufacturing tolerances coincide, an automatic creeping or loosening of the runner plate from the rolling bearing ring may occur.

The document U.S. Pat. No. 3,833,278 A discloses a runner plate which is formed by non-cutting machining and the hub of which is positioned on an inner ring of a rolling bearing, the rolling bearing outer ring being secured in position in a fixed housing. The disadvantage of this design is that a rolling bearing with an inner ring and with an outer ring is required in order to mount the runner plate. This makes it more difficult to produce the runner plate, since, on the one hand, the bearing rings have to be manufactured and mounted, and, on the other hand, because of the complicated cross-sectional shape of the runner plate hub, it is necessary to secure the inner ring via a rim, thus correspondingly increasing the production costs of the runner plate.

A further runner plate involving a two-part construction is known from DE 2 203 681 A1. A belt pulley face, as it is known, is in this case provided with a spoke-shaped flange, the hub including shaped-in rolling body raceways. To form a rolling bearing, the rolling bodies are guided on the outside on a fixed bearing part.

### OBJECT OF THE INVENTION

The object on which the invention is based is to provide a cost-effective runner plate optimized in component terms.

### SUMMARY OF THE INVENTION

According to the features of the main claim, the runner plate, configured in one piece as a non-cutting-machined part, comprises a cross-sectional profile of C-shaped configuration, the hub at the same time assuming the function of a rolling bearing ring. For this purpose, at least one raceway is shaped by non-cutting machining into the hub for the reception and guidance of rolling bodies. The design according to the invention avoids the above-mentioned disadvantages, in that the one-piece runner plate is produced in a non-cutting shaping method such that this method at the same time includes the shaping of a raceway for the reception and guidance of rolling bodies. This measure gives rise to a secure positioning in place for the one-piece runner plate in the operating state, since the rolling bodies, as it were, bring about a positive securing of the runner plate on the rolling bearing. At the same time, the component range and the weight of the runner plate are reduced. The method for producing the runner plate may advantageously be coordinated such that a confined manufacturing tolerance is established, with the result that a closely delimitable radial clearance required for the functioning of the rolling mounting is obtained. This method can be employed, since, after the shaping method for producing the runner plate, no subsequent joining operation or pressing operation influences the radial clearance of the rolling bearing.

Further advantageous refinements of the invention are the subject of the dependent claims 2-11.

Advantageously, the hub of the one-piece runner plate may be designed such that it assumes the function of an outer ring or of an inner ring of the rolling bearing. Thus, depending on the surrounding structure, the rolling body raceway may be shaped into the surface area of the hub or, alternatively, in the region of the inner wall of the hub.

As a preferred shaping method for producing the runner plate, a deep-drawing method is provided, by means of which the runner plate can be produced by non-cutting machining from sheet steel. Alternatively to this, an extrusion method is appropriate so that a cost-effective runner plate can be produced by non-cutting machining. Irrespective of the method employed, the raceway for the rolling bodies is shaped directly into the hub of the runner plate.

Furthermore, the invention includes, as required, a secondary treatment of the raceway, for which purpose various methods can be employed in order to optimize the friction and/or to reduce the generation of noise. For secondary treatment, the raceway may be tumbled, cold-rolled or forged. An alignment of the fibers in the material structure and therefore strain hardening are thereby achieved. This measure has a positive effect on the load-bearing capacity, the carrying coefficient, of the bearing, with the result that the service life can be increased. A further appropriate measure is to introduce the rolling body raceway by non-cutting machining into the hub of the runner plate after the latter has previously been partially hardened and ground.

In a further advantageous refinement of the invention, two axially spaced-apart raceways for the rolling bodies are introduced into the hub in order to produce a two-row rolling bearing. The carrying capacity of the rolling bearing can consequently be increased, with the result that the design according to the invention can also be used for runner plates subjected to high load.

As a further measure for optimizing the carrying capacity of the rolling mounting, the runner plate according to the invention has in the region of the hub a wall thickness which exceeds a wall thickness of the conventional runner plate regions. This measure ensures, in the region of the rolling mounting, a rigid configuration having firm components, this being advantageous particularly for runner plates which are to be designed for high rotational speeds.

A further optimization of the carrying capacity of the rolling mounting may take place by means of directed technological coordination and by the use of special materials.

Preferably, the runner plate according to the invention includes, in the region of the hub, a cylindrical portion which is intended for receiving a sealing ring. The sealing ring, fastened fixedly to the hub and rotating with the hub, is advantageously configured such that an axial or end-face covering of the rolling bearing is obtained. For this purpose, it is appropriate to provide the sealing ring with an elastic sealing lip which, with a low gap dimension being maintained, is guided as far as the associated further bearing ring of the rolling bearing or is supported on this bearing ring with low force. The sealing ring used is advantageously provided with a reinforcement which is bent at right angles and which is fastened non-positively in or on the receptacle of the hub of the runner plate by means of a press fit. In this case, it is appropriate to coat or to provide with a rubber film that portion of the reinforcement which is connected to the hub, with the result that an escape of lubricant from the rolling bearing is effectively prevented.

### BRIEF DESCRIPTION OF THE DRAWINGS

Exemplary embodiments of the invention are shown in the Figures which are described below and in which:

FIG. 1 shows a half-sectional illustration of a runner plate according to the invention which with a separate bearing ring forms a single-row rolling bearing;

FIG. 2 shows a runner plate according to the invention which is likewise depicted in half section and which is mounted rotatably via a two-row rolling bearing.

### DETAILED DESCRIPTION OF THE DRAWINGS

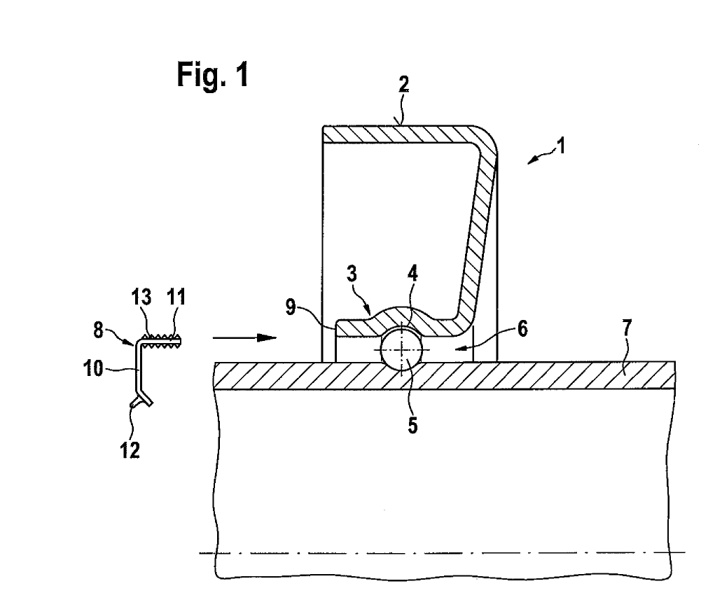

The runner plate 1, illustrated in section according to FIG. 1, is produced by means of a non-cutting shaping process, in particular a deep-drawing method. The runner plate 1 in this case forms a C-shaped cross-sectional profile open on one side. In the installation state, a traction means, not depicted in FIG. 1, in particular a belt, is guided on a surface area 2 of the runner plate 1. The runner plate 1 forms, spaced apart radially from the surface area 2r a hub 3 having a longitudinal extent which is reduced in relation to the surface area 2. The hub 3 has shaped into it by non-cutting machining a raceway 4 which is intended as a receptacle and guide for rolling bodies 5 of a rolling bearing 6. The hub 3 consequently assumes the function of an outer bearing ring of the rolling bearing 6, to which is assigned on the inside an inner ring 7 which is fixed, for example, on a shaft, not depicted in FIG. 1.

Alternatively to this, it is appropriate to configure the rolling bearing 6 without separate bearing rings, the rolling bodies 5 being guided on the inside in a raceway of a shaft. According to the invention, it is appropriate to produce the raceway 4 directly in conjunction with the process for the non-cutting shaping of the runner plate 1. To optimize the raceway quality, this may be tumbled, cold-rolled, forged or ground, in order, for example, to produce an alignment of the fibers in the material structure, with the result that the load-bearing capacity, the carrying coefficient, of the bearing can be increased. Furthermore, the invention includes a partial hardening of the runner plate 1 in the region of the hub 4 or solely in the region of the raceway 4, this likewise having an advantageous effect on the carrying capacity of the rolling bearing 6.

Moreover, the configuration of the runner plate 1 according to the invention includes measures for the directed sealing off of the rolling bearing 6. For this purpose, a sealing ring 8 is provided, which is fastened to a cylindrical portion 9 of the hub 3. To fix the sealing ring 8 in a simple way, the latter is provided with a reinforcement 10, of which the leg 11 oriented at right angles is pressed non-positively into the hub 3 in the region of the cylindrical portion 9. Alternatively to this, it is appropriate to configure the reinforcement 10 such that its leg 11 surrounds the cylindrical portion 9 on the outside. In the installed state, the sealing ring 8, enlarged, in FIG. 1, is guided as far as a surface area of the inner ring 7, with a gap dimension being maintained. Alternatively to this, it is appropriate for a sealing lip 12 of the sealing ring 8 to be supported with low bearing force against the inner ring 7. Furthermore, the leg 11 of the reinforcement 10 is provided with a rubber film 13 or, alternatively, with a coating which, in the installation state of the sealing ring 8, ensures effective sealing off between the hub 3 and the reinforcement 10. To obtain a rolling bearing 6 which is sealed off on both sides, a further sealing ring 8 may be pressed into the hub 3 on that side of the rolling bearing 6 which faces away from the cylindrical portion 9.

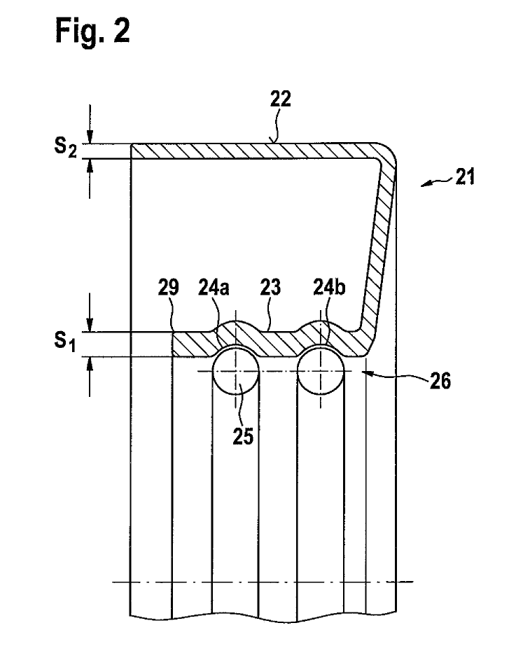

FIG. 2 shows the runner plate 21 which has a greater component breadth, as compared with the runner plate 1 according to FIG. 1. The cross-sectional profile, likewise of C-shaped configuration, of the runner plate 21 is delimited radially on the outside by the surface area 22 and radially on the inside by the hub 23. The hub 23 is provided with two raceways 24a, 24b, shaped so as to be offset axially with respect to one another, for the rolling bodies 2S of the rolling bearing 26. The non-cutting production method provided for producing the runner plate 21 likewise includes the shaping of the raceways 24a, 24b. To achieve a higher rigidity of the runner plate 21, which at the same time increases the carrying capacity of the rolling bearing 26, the wall thickness “S₁” of the hub 23 exceeds the wall thickness “S₂” in the remaining portions of the runner plate 21. To seal off the rolling bearing 26 of two-row construction, the hub 23 forms a free projecting cylindrical portion 29 which may be utilized for the reception or fastening of, for example, a sealing ring 8 according to FIG. 1.

### LIST OF REFERENCE NUMERALS

1 Runner plate
2 Surface area
3 Hub
4 Raceway
5 Rolling body
6 Rolling bearing
7 Inner ring
8 Sealing ring
9 Portion
10 Reinforcement
11 Leg
12 Sealing lip
13 Rubber film
21 Runner plate
22 Surface area
23 Hub
24a Raceway
24b Raceway
25 Rolling body
26 Rolling bearing
29 Portion

1. A runner plate for a traction drive, designed as a one-piece non-cutting-machined part, on the surface area of which a traction means is guided and the hub of which cooperates with a rolling bearing, wherein the hub of the runner plate of C-shaped configuration forms at the same time a rolling bearing ring and for this purpose at least one raceway for the reception and guidance of rolling bodies is shaped into the hub.

2. The runner plate as claimed in claim 1, wherein the hub assuming the function of an outer ring or of an inner ring of the rolling bearing.

3. The runner plate as claimed in claim 1, which is produced from a sheet steel by non-cutting machining by means of a deep-drawing method.

4. The runner plate as claimed in claim 1, for the production of which an extrusion method is provided.

5. The runner plate as claimed in claim 1, which includes tumbling, cold-rolling, forging or grinding for the secondary treatment of the raceway.

6. The runner plate as claimed in claim 1, wherein the raceway is shaped into the hub after partial hardening.

7. The runner plate as claimed in claim 1, wherein two axially spaced-apart raceways for the rolling bodies being shaped into the hub.

8. The runner plate as claimed in claim 1, wherein the wall thickness in the region of the hub exceeds the wall thickness of all the remaining runner plate regions.

9. The runner plate as claimed in claim 1, wherein a free cylindrical portion of the hub is intended for receiving a sealing ring by means of which the rolling bearing is sealed off.

10. The runner plate as claimed in claim 9, wherein the sealing ring being fastened non-positively to the portion of the hub by means of a reinforcement bent at right angles.

11. The runner plate as claimed in claim 10, wherein in which the reinforcement of the sealing ring is supported on the portion of the hub via a coated leg.
